(19) United States
(12) Patent Application Publication
(10) Pub. No.: US 2009/0006209 A1
(43) Pub. Date: Jan. 1, 2009

(54) Overprint and Reprint

(75) Inventor: Oren Sokolowsky, Kfar-Saba (IL)

Correspondence Address: DARBY & DARBY P.C., P.O. BOX 770, Church Street Station, New York, NY, 10008-0770, US

(73) Assignee: Verifone Israel Ltd., Rosh Haayin (IL)

(21) Appl. No.: 12/158,197

(22) PCT Filed: Jan. 4, 2007
(86) PCT No.: PCT/IL2007/000009

§ 371 Date: Sep. 12, 2008

(30) Foreign Application Priority Data
Jan. 5, 2006 (IL) 172987

(51) Int. Cl. G06Q 30/00

(52) U.S. Cl. 705/14; 705/24

(57) ABSTRACT

A point of sale terminal including a printer and electronic circuitry governing the operation of the printer, the electronic circuitry including transaction voiding responsive functionality for providing a visual indication of transaction voiding on transaction documentation.

### FIELD OF THE INVENTION

The present invention relates to point of sale terminals generally.

### BACKGROUND OF THE INVENTION

The following patent documents are believed to represent the current state of the art:

U.S. Pat. Nos. 4,493,037; 5,038,284 and 5,812,668.

### SUMMARY OF THE INVENTION

The present invention seeks to provide receipt cancellation functionality in point of sale terminals generally. The phrase “point of sale terminal” refers generally to electronic devices used at a point of sale which generate printed receipts, such as POS devices and electronic cash registers, examples of which are commercially available from VeriFone, Inc. of San Jose, Calif.

There is thus provided in accordance with a preferred embodiment of the present invention a point of sale terminal including a printer and electronic circuitry governing the operation of the printer, the electronic circuitry including transaction voiding responsive functionality for providing a visual indication of transaction voiding on transaction documentation.

In accordance with a preferred embodiment of the present invention the transaction voiding responsive functionality includes operator-actuation functionality for enabling an operator to cause transaction documentation already printed to be marked so as to visually indicate the transaction voiding. Preferably, the visual indication is a word.

In accordance with another preferred embodiment of the present invention the transaction documentation is a transaction receipt. Alternatively, the transaction documentation is a coupon.

There is also provided in accordance with another preferred embodiment of the present invention a point of sale terminal including a printer and electronic circuitry governing the operation of the printer, the electronic circuitry including automatic condition responsive documentation modification functionality for automatically causing transaction documentation already printed to be modified so as to visually indicate the cancellation thereof in response to a sensed condition.

In accordance with a preferred embodiment of the present invention the sensed condition is an interruption of electrical power to the point of sale terminal. Preferably, the automatic condition responsive documentation modification functionality modifies the transaction documentation by marking the receipt with a visual indication. More preferably, the visual indication is a word.

In accordance with a further preferred embodiment of the present invention the transaction documentation is a receipt. Alternatively, the transaction documentation is a coupon.

There is further provided in accordance with yet another preferred embodiment of the present invention a method for voiding a transaction, including printing transaction documentation utilizing a printer and while the transaction documentation is connected to the printer, employing electronic circuitry governing the operation of the printer and including transaction voiding responsive functionality for providing a visual indication of transaction voiding on the transaction documentation.

In accordance with yet another preferred embodiment of the present invention the employing includes actuating operator-actuation functionality thereby causing the transaction documentation to be marked so as to visually indicate the transaction voiding. Preferably, the visual indication is a word.

There is additionally provided in accordance with a further preferred embodiment of the present invention a method for modifying transaction documentation, including printing the transaction documentation utilizing a printer and while the transaction documentation is connected to the printer, employing electronic circuitry governing the operation of the printer and including automatic condition responsive documentation modification functionality, thereby automatically causing the transaction documentation to be modified so as to visually indicate the cancellation thereof in response to a sensed condition.

Preferably, in accordance with yet another preferred embodiment of the present invention the sensed condition is an interruption of electrical power to the receipt printer.

### BRIEF DESCRIPTION OF THE DRAWINGS

The present invention will be understood and appreciated from the following detailed description, taken in conjunction with the drawings in which:

FIG. 1 is a simplified pictorial illustration of a point of sale terminal constructed and operative in accordance with a preferred embodiment of the present invention;

FIG. 2 is a simplified pictorial illustration of a point of sale terminal constructed and operative in accordance with another preferred embodiment of the present invention;

FIG. 3 is a simplified pictorial illustration of a point of sale terminal constructed and operative in accordance with yet another preferred embodiment of the present invention;

FIG. 4 is a simplified block diagram illustration of electronic circuitry useful in the present invention; and

FIG. 5 is a simplified flow chart illustrating the operation of the apparatus of FIGS. 1A-4.

### DETAILED DESCRIPTION OF PREFERRED EMBODIMENTS

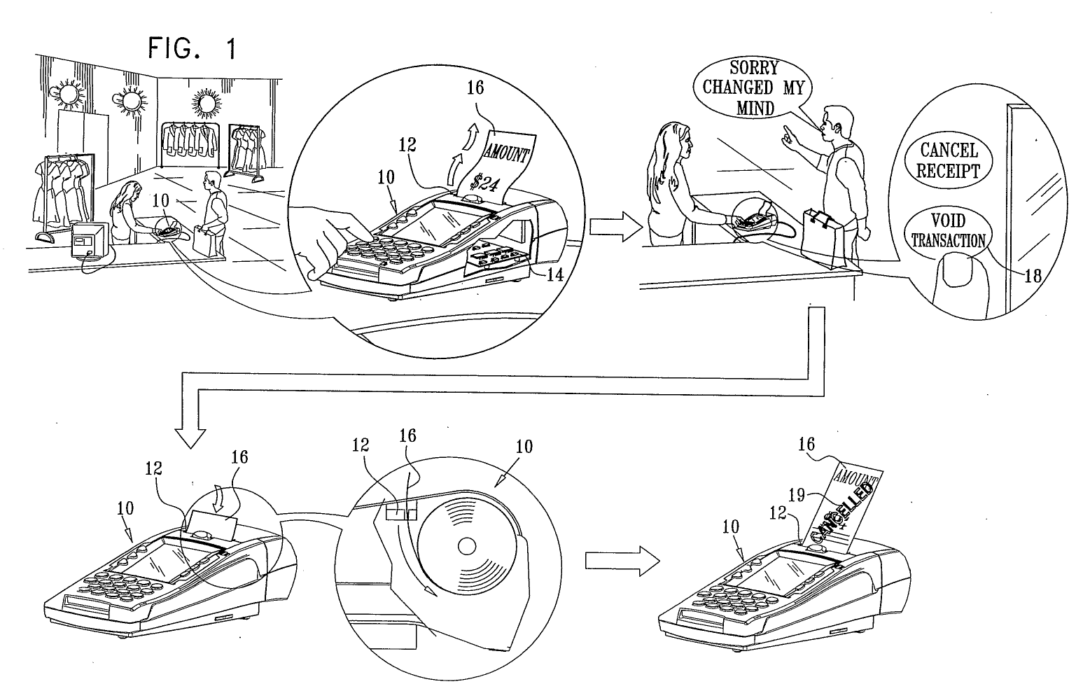

Reference is now made to FIG. 1, which is a simplified pictorial illustration of a point of sale terminal constructed and operative in accordance with a preferred embodiment of the present invention. As seen in FIG. 1, there is provided a point of sale terminal 10, such as a NURIT™ 8210; NURIT™ 8100; NURIT™ 2056 and NURIT™ 2059 POS, commercially available from VeriFone, Inc. of San Jose, Calif. The point of sale terminal 10 includes a receipt printer 12 and electronic circuitry 14, which preferably includes software which is employed to implement the present invention.

As seen in FIG. 1, the point of sale terminal 10 is operative to print a customer receipt 16. If, for any suitable reason, such as a customer's wish to void a transaction, the operator, such as a sales clerk, can press any suitable button or combination of buttons on the point of sale terminal 10, such as a VOID TRANSACTION button 18.

In accordance with a preferred embodiment of the present invention, pressing of the VOID TRANSACTION button 18, results in voiding of the transaction for accounting, authorization and settlement purposes and also drives receipt printer 12 in a paper roll retraction mode causing a reversal in the normal direction of paper drive therethrough, such that the already printed receipt 16 or a portion thereof is retracted into the receipt printer 12. The pressing of the VOID TRANSACTION button 18 further causes the printer, following retraction, to mark previously printed receipt 16 with a visually sensible receipt cancellation indication 19. Preferably, the visually sensible receipt cancellation indication 19 is a word, such as CANCELLED.

It is appreciated that the system and method of FIG. 1 may alternatively be employed for indicating the cancellation of a coupon, or any other suitable transaction documentation.

It is also appreciated that the system and method of FIG. 1 is suitable for situations in which transaction details are transmitted to a processor of credit or debit transactions, wherein a card such as a credit or debit card is swiped in a point of sale terminal, as well as situations in which a point of sale terminal or a cash register transmits transaction data to back-office programs for accounting purposes and/or for loyalty programs.

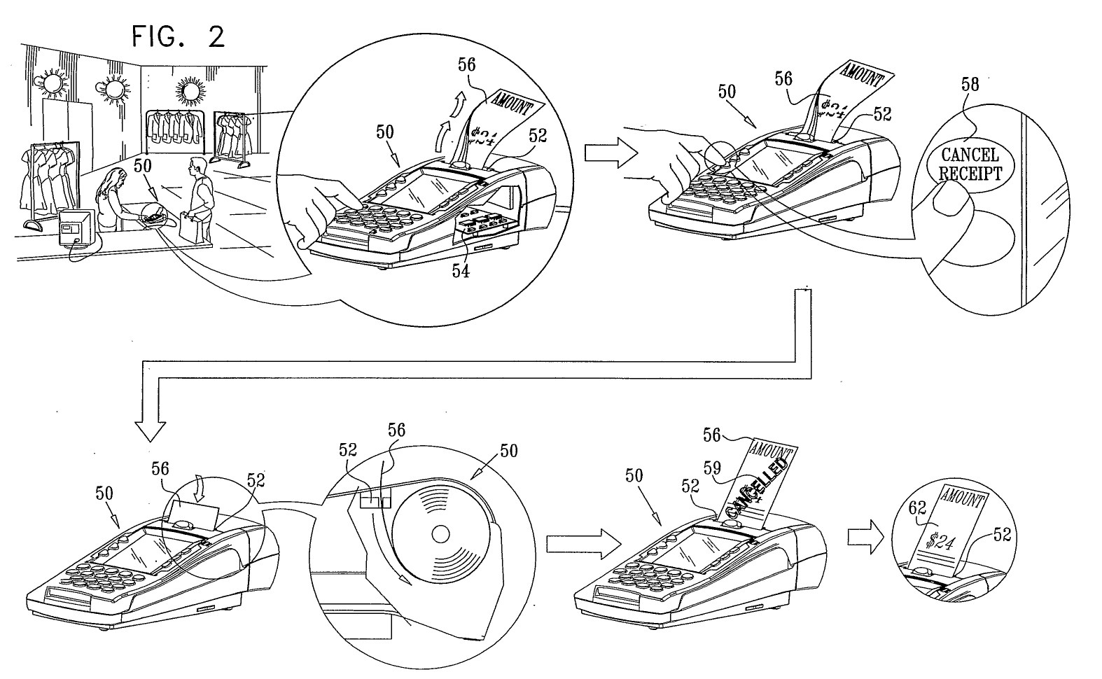

Reference is now made to FIG. 2, which is a simplified pictorial illustration of a point of sale terminal constructed and operative in accordance with another preferred embodiment of the present invention. As seen in FIG. 2, there is provided a point of sale terminal 50, such as a NURIT™ 8210; NURIT™ 8100; NURIT™ 2056 and NURIT™ 2059 POS commercially available from VeriFone, Inc. of San Jose, Calif. The point of sale terminal 50 includes a receipt printer 52 and electronic circuitry 54, which preferably includes software which is employed to implement the present invention.

As seen in FIG. 2, the point of sale terminal 50 is operative to print a customer receipt 56. If, for any suitable reason, such as a merchant's need to void a receipt, for example due to a misfeed or corrupted receipt printing, while not voiding the transaction, the operator, such as a sales clerk can press any suitable button or combination of buttons on the point of sale terminal 50, such as a CANCEL RECEIPT button 58.

In accordance with a preferred embodiment of the present invention, pressing of the CANCEL RECEIPT button 58, drives receipt printer 52 in a paper roll retraction mode causing a reversal in the normal direction of paper drive therethrough, such that the already printed receipt 56 or a portion thereof is retracted into the receipt printer 52. The pressing of the CANCEL RECEIPT button 58 further causes the printer, following retraction, to mark the previously printed receipt 56 with a visually sensible receipt cancellation indication 59 and to print a new receipt 62. Preferably the visually sensible receipt cancellation indication 59 is a word, such as CANCELLED. The transaction is not voided.

It is appreciated that the functionalities of FIGS. 1 and 2 are preferably, but need not necessarily, be combined in a single point of sale terminal.

It is appreciated that the system and method of FIG. 2 may alternatively be employed for indicating the cancellation of a coupon, or any other suitable transaction documentation.

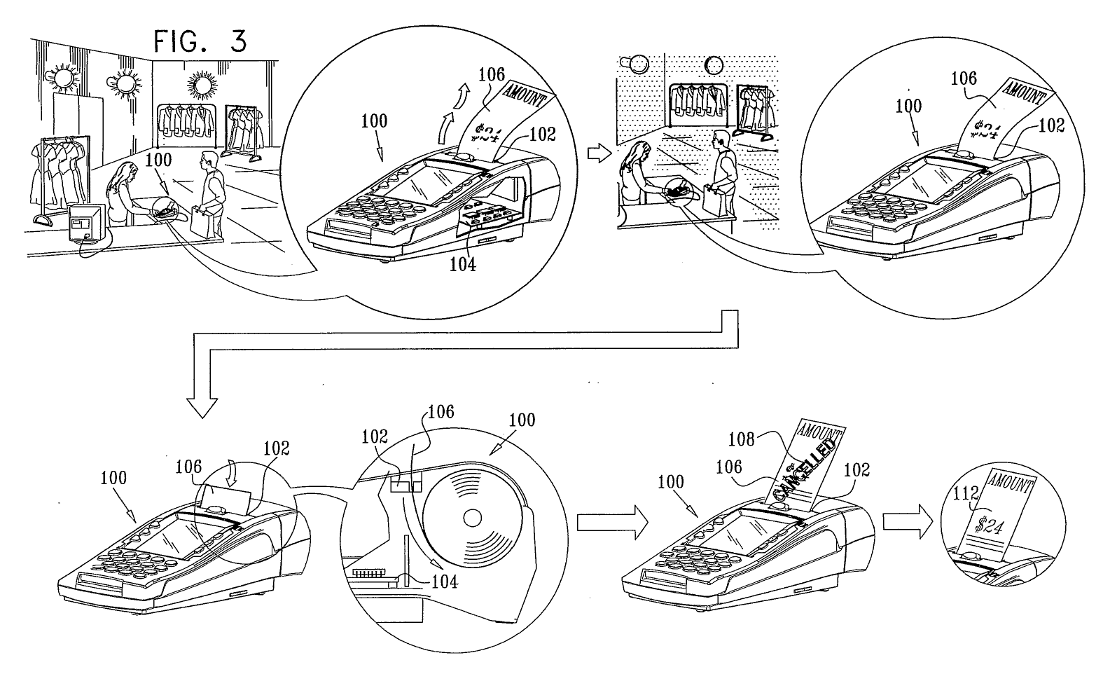

Reference is now made to FIG. 3, which is a simplified pictorial illustration of a point of sale terminal constructed and operative in accordance with yet another preferred embodiment of the present invention. As seen in FIG. 3, there is provided a point of sale terminal 100, such as a NURIT™ 8210; NURIT™ 8100; NURIT™ 2056 and NURIT™ 2059 POS commercially available from VeriFone, Inc. of San Jose, Calif. The point of sale terminal 100 includes a receipt printer 102 and electronic circuitry 104, which preferably includes software which is employed to implement the present invention.

As seen in FIG. 3, the point of sale terminal 100 is operative to print a customer receipt 106. If, for any suitable reason, such as for example, a power failure, mechanical misprint, paper misfeed or paper exhaustion, all of which are sensible by electronic circuitry 104 or circuitry associated therewith, the printed receipt is not in an acceptable form, the electronic circuitry 104 automatically drives receipt printer 102 in a paper roll retraction mode causing a reversal in the normal direction of paper drive therethrough, such that the already printed receipt 106 or a portion thereof is retracted into the receipt printer 102. The printer, following retraction of the receipt 106, automatically marks the previously printed receipt 106 with a visually sensible receipt cancellation indication 108 and prints a new receipt 112. Preferably, the visually sensible receipt cancellation indication 108 is a word, such as CANCELLED. The transaction is not voided.

It is appreciated that the functionalities of some or all of FIGS. 1, 2 and 3 are preferably, but need not necessarily, be combined in a single point of sale terminal.

It is appreciated that the system and method of FIG. 3 may alternatively be employed for indicating the cancellation of a coupon, or any other suitable transaction documentation.

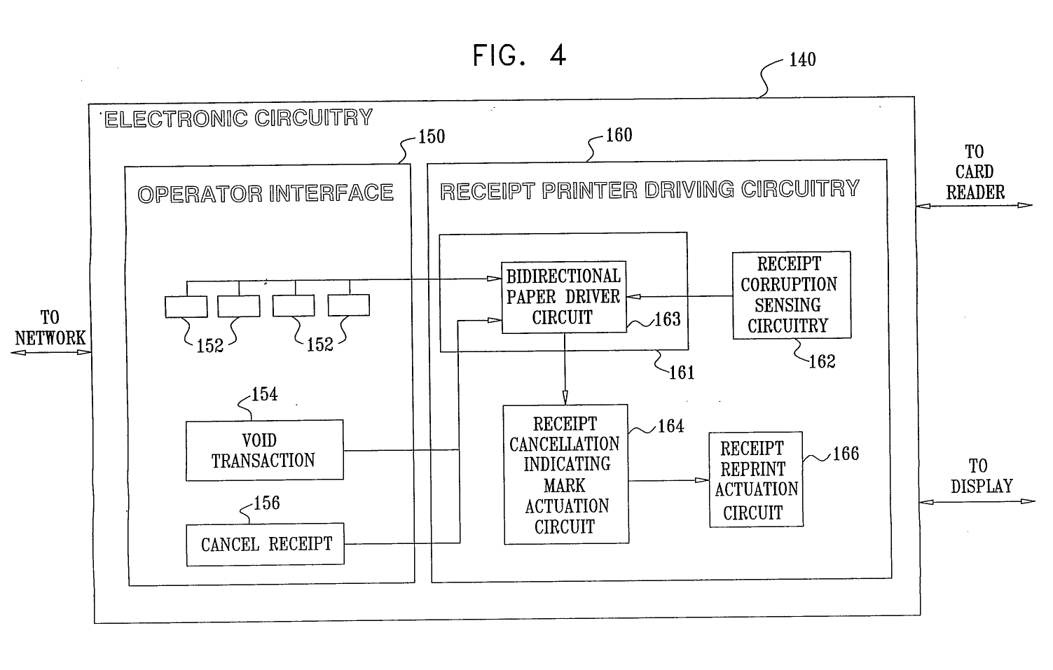

Reference is now made to FIG. 4, which is a simplified block diagram illustration of electronic circuitry 140, such as circuitry 14, 54 and 104, useful in the present invention having some or all of the functionalities described hereinabove with respect to FIGS. 1-3. As seen in FIG. 4, the electronic circuitry 140 preferably includes an operator interface 150 which typically includes transaction entry buttons 152 as well as a VOID TRANSACTION button 154 and a CANCEL RECEIPT button 156. The electronic circuitry preferably interfaces with one or more card readers (not shown), a display (not shown) and with a wired and or wireless communications network (not shown).

The electronic circuitry also comprises receipt printer driving circuitry 160 including printing circuitry 161 which receives input from transaction entry buttons 152, VOID TRANSACTION button 154 and CANCEL RECEIPT button 156, and receipt corruption sensing circuitry 162. Printing circuitry 161 includes a bi-directional paper driver circuit 163. Receipt printer driving circuitry 160 also includes a receipt cancellation-indicating mark actuation circuit 164 which receives input from bi-directional paper driver circuit 163, following input thereto from the VOID TRANSACTION button 154, the CANCEL RECEIPT button 156 or the receipt corruption sensing circuitry 162, and a receipt reprint actuation circuit 166 which receives input from receipt cancellation-indicating mark actuation circuit 164.

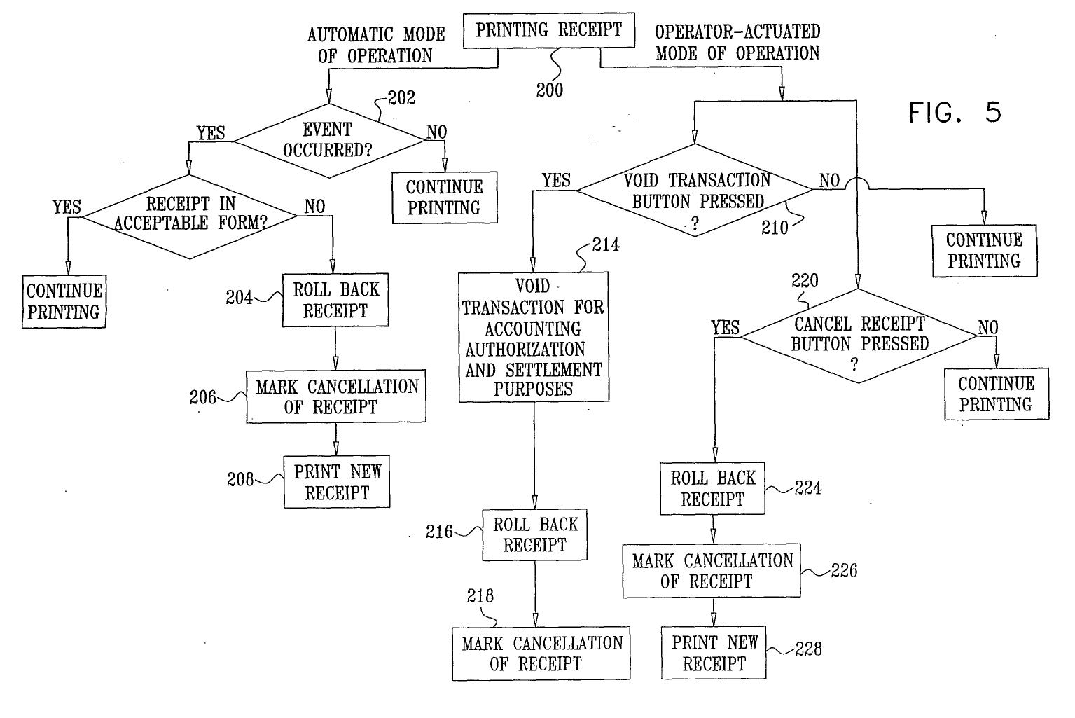

Reference is now made to FIG. 5, which is a simplified flow chart illustrating the operation of the apparatus of FIGS. 1-4, having some or all of the functionalities described hereinabove with respect to FIGS. 1-3. As seen in FIG. 5 following complete or incomplete printing of a customer receipt, the apparatus of FIGS. 1-4 may be operative in an automatic mode of operation to effect receipt cancellation-indicating marking of a receipt in response to one or more automatically sensed conditions.

Typically, a point of sale terminal similar to point of sale terminals 10, 50 and 100 of FIGS. 1-3, including a receipt printer similar to receipt printers 12, 52 and 102 of FIGS. 1-3, prints at least part of a receipt for the client, as indicated in block 200.

At any given time during printing the receipt, electronic circuitry such as electronic circuitry 14, 54 and 104 of FIGS. 1-3 senses whether an event, such as a power failure or a mechanical misprint, has occurred, as indicated in block 202.

If the partially printed receipt is in acceptable form, the printing continues as usual. Otherwise, the receipt printer is driven in a paper roll retraction mode, as indicated in block 204, thereby retracting the printed receipt or a portion thereof into the receipt printer.

Following the retraction of the receipt, the printer automatically marks the previously printed receipt with a visually sensible receipt cancellation indication, as indicated in block 206. Preferably, the printer also prints a new receipt, as indicated in block 208.

Additionally or alternatively, following complete or incomplete printing of a customer receipt, the apparatus of FIGS. 1-4 may be operative in an operator-actuated mode of operation to effect receipt cancellation-indicating marking of a receipt.

Typically, a point of sale terminal similar to point of sale terminals 10, 50 and 100 of FIGS. 1-3, including a receipt printer similar to receipt printers 12, 52 and 102 of FIGS. 1-3, prints at least part of a receipt for the client.

At any given time during printing the receipt, electronic circuitry such as bi-directional paper driver circuit 163 of FIG. 4, senses whether the VOID TRANSACTION button 154 has been pressed, as indicated in block 210.

Pressing the VOID TRANSACTION button results in the point of sale terminal canceling the transaction for accounting, authorization and settlement purposes as indicated in block 214, and driving the receipt printer in a paper roll retraction mode, indicated in block 216, thereby retracting the printed receipt or a portion thereof into the receipt printer.

Following the retraction of the receipt, the printer automatically marks the previously printed receipt with a visually sensible receipt cancellation indication, as indicated in block 218.

Alternatively or additionally, if electronic circuitry such as bi-directional paper driver circuit 163 of FIG. 4, senses that the CANCEL RECEIPT button 156 has been pressed, as indicated in block 220, the receipt printer is driven in a paper roll retraction mode, indicated in block 224, thereby retracting the printed receipt or a portion thereof into the receipt printer. However, the transaction is not voided.

Following the retraction of the receipt, the printer automatically marks the previously printed receipt with a visually sensible receipt cancellation indication, as indicated in block 226. Preferably, the printer also prints a new receipt, as indicated in block 228.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A point of sale terminal comprising:
a printer; and
electronic circuitry governing the operation of said printer, said electronic circuitry including transaction voiding responsive functionality for providing a visual indication of transaction voiding on transaction documentation.

2. A point of sale terminal according to claim 1 and wherein said transaction voiding responsive functionality includes operator-actuation functionality for enabling an operator to cause transaction documentation already printed to be marked so as to visually indicate the transaction voiding.

3. A point of sale terminal according to claim 1 and wherein said visual indication comprises a word.

4. A point of sale terminal according to claim 1 and wherein said transaction documentation comprises a transaction receipt.

5. A point of sale terminal according to claim 1 wherein said transaction documentation comprises a coupon.

6. A point of sale terminal comprising:
a printer; and
electronic circuitry governing the operation of said printer, said electronic circuitry including automatic condition responsive documentation modification functionality for automatically causing transaction documentation already printed to be modified so as to visually indicate the cancellation thereof in response to a sensed condition.

7. A point of sale terminal according to claim 6 and wherein said sensed condition is an interruption of electrical power to said point of sale terminal.

8. A point of sale terminal according to claim 6 and wherein said automatic condition responsive documentation modification functionality modifies said transaction documentation by marking said transaction documentation with a visual indication.

9. A point of sale terminal according to claim 8 and wherein said visual indication comprises a word.

10. A point of sale terminal according to claim 6 and wherein said transaction documentation comprises a receipt.

11. A point of sale terminal according to claim 6 and wherein said transaction documentation comprises a coupon.

12. A method for voiding a transaction, comprising:
printing transaction documentation utilizing a printer; and
while said transaction documentation is connected to said printer, employing electronic circuitry governing the operation of said printer and including transaction voiding responsive functionality for providing a visual indication of transaction voiding on said transaction documentation.

13. A method according to claim 12 and wherein said employing comprises actuating operator-actuation functionality thereby causing said transaction documentation to be marked so as to visually indicate the transaction voiding.

14. A method according to claim 12 and wherein said visual indication comprises a word.

15. A method for modifying transaction documentation, comprising:
printing said transaction documentation utilizing a printer; and
while said transaction documentation is connected to said printer, employing electronic circuitry governing the operation of said printer and including automatic condition responsive documentation modification functionality, thereby automatically causing said transaction documentation to be modified so as to visually indicate the cancellation thereof in response to a sensed condition.

16. A method according to claim 15 and wherein said sensed condition is an interruption of electrical power to said printer.
